(19) United States
(12) Patent Application Publication
(10) Pub. No.: US 2006/0088069 A1
(43) Pub. Date: Apr. 27, 2006

(54) Uncooled, low profile, external cavity wavelength stabilized laser, and portable Raman analyzer utilizing the same

(76) Inventors: Daryoosh Vakhshoori, Cambridge, MA (US); Peidong Wang, Carlisle, MA (US); Masud Azimi, Belmont, MA (US)

Correspondence Address: Pandiscio & Pandiscio, P.C., 470 Totten Pond Road, Waltham, MA, 02451-1914, US

(21) Appl. No.: 11/215,662

(22) Filed: Aug. 30, 2005

Related U.S. Application Data
(63) Continuation-in-part of application No. 11/119,076, filed on Apr. 29, 2005.
(60) Provisional application No. 60/605,697, filed on Aug. 30, 2004.

(51) Int. Cl. H01S 3/13; H01S 3/08

(52) U.S. Cl. 372/32; 372/102; 372/92

(57) ABSTRACT

The current invention relates to several different ways to realize “uncooled lasers” (i.e., a laser source without a temperature stabilization element, such as a thermal electric cooler) which have a sufficiently stable, narrow-linewidth source as to be useful as a Raman pump source in portable instruments and systems. These include desensitizing the laser wavelength against mechanical deformations and distortions caused by the temperature changes around the laser source. In addition, the present invention also discloses improved techniques for reducing the profile of the uncooled, wavelength stabilized laser, so as to facilitate its use in portable applications, including hand-held Raman analyzers.

### REFERENCE TO PENDING PRIOR PATENT APPLICATIONS

This patent application:

(i) is a continuation-in-part of pending prior U.S. patent application Ser. No. 11/119,076, filed Apr. 29, 2005 by Daryoosh Vakhshoori et al. for EXTERNAL CAVITY WAVELENGTH STABILIZED RAMAN LASERS INSENSITIVE TO TEMPERATURE AND/OR EXTERNAL MECHANICAL STRESSES, AND RAMAN ANALYZER UTILIZING THE SAME (Attorney's Docket No. AHURA-24);

(ii) claims benefit of pending prior U.S. Provisional Patent Application Ser. No. 60/605,694, filed Aug. 30, 2004 by Daryoosh Vakhshoori et al. for USE OF UNCOOLED LASERS IN PORTALE RAMAN APPLICATIONS (Attorney's Docket No. AHURA-25 PROV); and

(iii) claims benefit of pending prior U.S. Provisional Patent Application Ser. No. 60/605,603, filed Aug. 30, 2004 by Daryoosh Vakhshoori et al. for METHOD OF MAKING LOW PROFILE FREQUENCY STABILIZED LASERS (Attorney's Docket No. AHURA-27 PROV).

The above-identified patent applications are hereby incorporated herein by reference.

### FIELD OF THE INVENTION

This invention relates to lasers in general, and more particularly to semiconductor lasers.

### BACKGROUND OF THE INVENTION

Applications using Raman scattering signatures to identify unknown materials is expanding rapidly, e.g., in the areas of security and safety, biotechnology, biomedicine, industrial process control, pharmaceuticals and other markets. This is due to the rich and detailed optical signatures made possible by analyzing Raman scattering off the specimen.

In these Raman analyzers, a laser is used to generate a stable and narrow linewidth light signal which is used as the source of the Raman pump. However, for portable applications, small size and low electrical power consumption efficiency is of the essence. This is because the laser in such a system can account for the majority of the power consumption, and hence dominate the battery lifetime of portable units.

Semiconductor lasers are one of the most efficient lasers known. Semiconductor lasers can have wall-plug efficiencies greater than 50%, which is quite rare for any other type of lasers. However, to wavelength-stabilize the semiconductor lasers that are traditionally used for Raman applications, at 785 nm or other operating wavelengths, the most commonly used technique is to provide a diffraction grating in an external cavity geometry so as to stabilize the wavelength of the laser and narrow its linewidth to few inverse centimeter (<50 cm−1). Since such an arrangement tends to be temperature-sensitive (i.e., temperature changes can cause thermal expansion of various elements of the assembly which can detune the alignment and change laser wavelength and/or linewidth), a thermo-electric cooler (TEC) is commonly used to stabilize the temperature to within couple of degrees. However, TECs themselves consume substantial amounts of power, making such an arrangement undesirable in portable applications where power consumption is an important consideration. In addition, the use of TECs adds to the size and weight of the device, which is also undesirable in portable applications.

More particularly, TECs reduce the battery life, and increase the size, of portable optical based instruments. In some cases, as much as 70% of the power consumption of a semiconductor component can be saved by using an uncooled component. Also, a smaller electronic circuit footprint is possible where a TEC can be omitted, since the control and temperature feedback circuit of the TEC, and the cooling power supply of the TEC, can be eliminated. Furthermore, an additional advantage is obtained with the elimination of the cooling power supply of a TEC. More particularly, typical TECs operate best at lower voltage levels, e.g., 2-3 volts. However, rechargeable portable batteries typically provide 4-5 volts. Efficiency is lost when converting from the 4-5V battery voltage to the 2-3V TEC voltage. This inefficiency is in addition to the power consumption of the TEC itself, and hence adds to the overall power consumption of the portable device.

Thus, there is a need for a low-power laser which can provide a stable, narrow-linewidth source without the need for an active temperature-controlling element (for the purposes of the present disclosure, we can consider such a laser as an “uncooled laser”).

In addition to the foregoing, portable applications generally require small and thin components. This is evident from the recent trend of handheld consumer products such as cellphones and the like. For applications such as portable Raman analyzers (or other types of analyzers) which are designed to identify materials using the optical signatures of those materials, and/or other types of devices (e.g., optical readers and spectroscopic applications), compact and low profile lasers are highly desirable.

In addition to the foregoing, it has also been found that if the platform (or substrate) carrying the system components becomes mechanically deformed or distorted due to temperature induced stress or mechanical stress, the wavelength of the laser can also be affected.

Thus, there is also a need for improved techniques for desensitizing the laser wavelength against the mechanical deformations and distortions of the platform.

### SUMMARY OF THE INVENTION

In accordance with the present invention, it has now been discovered that there are ways to make an external cavity grating laser robust against temperature changes without using “power-hungry” temperature controllers. Furthermore, these same approaches can be used to make a thin-film stabilized laser (i.e., a laser using thin film dispersive filters instead of a grating for wavelength stabilization) robust against temperature changes without using temperature controllers.

Thus, in the present disclosure there are disclosed several different ways to realize “uncooled lasers” which have a sufficiently stable, narrow-linewidth source as to be useful as a Raman pump source in portable instruments and systems, and in other applications requiring similar features.

In addition, in the present disclosure there is also disclosed improved techniques for reducing the profile of the uncooled, wavelength stabilized laser, so as to facilitate its use in portable applications, including hand-held Raman analyzers.

And in the present disclosure there are also disclosed improved techniques for desensitizing the laser wavelength against mechanical deformations and distortions.

In one form of the invention, there is provided a low profile external cavity wavelength stabilized laser system comprising:

a platform extending in an x-y plane;

a laser mounted to the platform;

a diffractor mounted to the platform; and

a lens mounted to the platform between the laser and the diffractor so as to transmit light therebetween, wherein the lens is formed so as to have a reduced size in the z direction.

In another form of the invention, there is provided a method for generating light, comprising:
providing a low profile external cavity wavelength stabilized laser system comprising:
   a platform extending in an x-y plane;
   a laser mounted to the platform;
   a diffractor mounted to the platform; and
   a lens mounted to the platform between the laser and the diffractor so as to transmit light therebetween, wherein the lens is formed so as to have a reduced size in the z direction; and
activating the laser.

In another form of the invention, there is provided a Raman analyzer comprising:
a light source for delivering excitation light to a specimen so as to generate the Raman signature for that specimen;
a spectrometer for receiving the Raman signature of the specimen and determining the wavelength characteristics of that Raman signature; and
analysis apparatus for receiving the wavelength information from the spectrometer and, using the same, identifying the specimen;
wherein the light source comprises a low profile external cavity wavelength stabilized laser system comprising:
   a platform extending in an x-y plane;
   a laser mounted to the platform;
   a diffractor mounted to the platform; and
   a lens mounted to the platform between the laser and the diffractor so as to transmit light therebetween, wherein the lens is formed so as to have a reduced size in the z direction.

In another form of the invention, there is provided a method for identifying a specimen, comprising:
delivering excitation light to the specimen so as to generate the Raman signature for that specimen;
receiving the Raman signature of the specimen and determining the wavelength characteristics of that Raman signature; and
identifying the specimen using the wavelength characteristics of the Raman signature;
wherein the excitation light is delivered to the specimen using a low profile external cavity wavelength stabilized laser system comprising:
   a platform extending in an x-y plane;
   a laser mounted to the platform;
   a diffractor mounted to the platform; and
   a lens mounted to the platform between the laser and the diffractor so as to transmit light therebetween, wherein the lens is formed so as to have a reduced size in the z direction.

### BRIEF DESCRIPTION OF THE DRAWINGS

These and other objects and features of the present invention will be more fully disclosed or rendered obvious by the following detailed description of the preferred embodiments of the invention, which are to be considered together with the accompanying drawings wherein like numbers refer to like parts, and further wherein:

FIG. 1 is a schematic illustration showing a typical Littrow external cavity grating stabilized configuration;

FIG. 2 is a schematic illustration showing a thermal expansion mismatch of laser, lens and grating mount changes in the retro-diffraction angle, and compensation of thermal expansion of the grating pitch;

FIG. 3 is a schematic illustration showing a system like that of FIG. 1 but with a lens mount having a wedge configuration;

FIG. 3A is a schematic illustration showing the elliptical beam coverage for the external cavity wavelength stabilized laser system of FIG. 1;

FIG. 4 is a schematic illustration showing a system like that of FIG. 1, but with a side-mounted broad area laser with appropriate mount material so as to reduce temperature sensitivity;

FIG. 4A is a schematic illustration showing a system like that of FIG. 4, but with a cut-down lens so as to reduce the height profile of the system;

FIG. 4B is a schematic illustration showing a system like that of FIG. 4A, but with a lens mount having a wedge configuration;

FIG. 4C is a schematic illustration showing a system like that of FIG. 4, but with a cut-down lens side-mounted to its lens mount;

FIG. 4D is a schematic illustration showing a system like that of FIG. 4C, but with a modified form of cut-down lens;

FIG. 5 shows a novel means for mounting the laser platform to an external surrounding platform so as to reduce the effect mechanical deformations and distortions; and

FIG. 6 is a schematic view showing a novel Raman analyzer formed in accordance with the present invention.

### DETAILED DESCRIPTION OF THE PREFERRED EMBODIMENTS

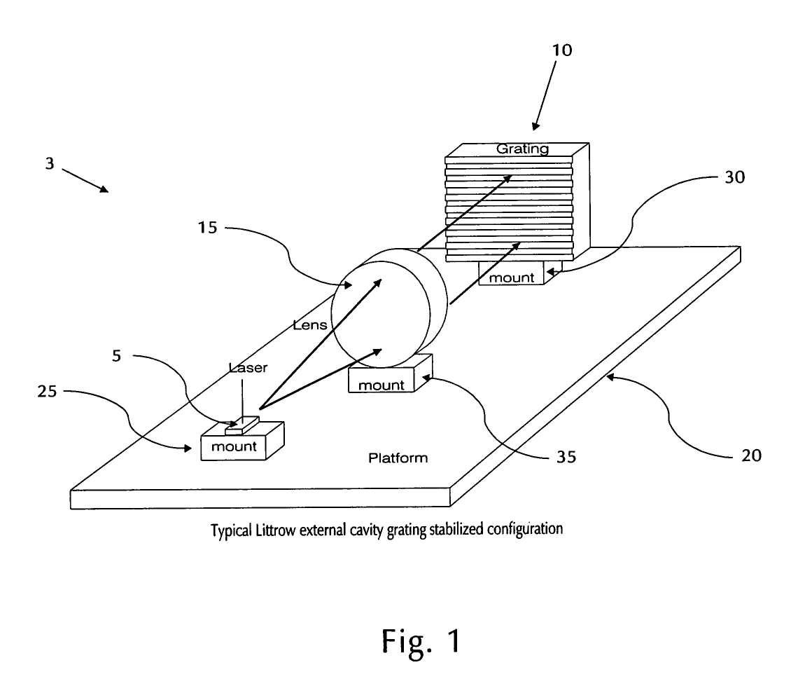

Looking first at FIG. 1, there is shown an external cavity wavelength stabilized laser system 3 which exemplifies the typical geometry for an external cavity wavelength stabilized laser system. In this geometry, the wavelength of a laser 5 is set by the diffraction grating 10, by virtue of the diffraction feedback coming off the diffraction grating and back into the laser. A lens 15 is positioned between laser 5 and diffraction grating 10 in order to focus the light rays. The laser 5, the diffraction grating 10 and the lens 15 are all attached to a platform (or substrate) 20 by means of mounts 25, 30 and 35, respectively.

More particularly, with the external cavity wavelength stabilized laser geometry shown in FIG. 1, the wavelength of the laser is set by the equation:
mλG=Sin(α)−Sin(β)
where “m” is the order of diffraction, “G” is the number of grating grooves per unit length, α is the angle of incidence on the grating, and β is the angle of diffraction from the grating. Lasing is established for the wavelength that allows the maximum diffraction back to the laser. This condition of equality of α and β means that the laser wavelength is determined by the angle that the grating is forming with the collimated laser output. This type of external cavity laser geometry is commonly known as Littrow geometry, and the particular incident angle (α_{L}) is commonly referred to as the Littrow angle.
m·A·G=2 Sin(α_{L})→λ=2·Sin(α_{L})/m·G

This Littrow geometry is sensitive to temperature.

One effect of wavelength temperature sensitivity is through the change in the diffraction angle necessary to satisfy the condition of equality of (i) the incident angle of a beam coming from the laser and impinging on the grating, with (ii) the diffraction angle of a beam coming back to the laser emitting facet. Obviously differential temperature expansions of the laser mount 25, lens mount 35 and grating mount 30 can cause this angle to change, thus resulting in a shift of the laser wavelength.

Another effect of temperature on wavelength is through thermal expansion of the grating pitch density G. In other words, as the temperature of the diffraction grating changes, the pitch of the grating's grooves changes, thus leading to a shift of the laser wavelength.

In summary, then, with the Littrow geometry, changes in temperature tend to result in changes in wavelength due to two effects. The first is a change in the Littrow angle through differential temperature expansion of the laser mount, the lens mount and/or the grating mount, and/or the lens and laser material; and the second is the thermal expansion of the grating material itself which affects the grating pitch density G.

In accordance with the present invention, it has been discovered that temperature insensitive wavelength stabilization can be achieved by carefully balancing these two effects. More particularly, by carefully choosing the laser mount, the lens mount and the grating mount materials and their dimensions, as well as the lens material and its dimensions, the laser wavelength shift due to these net thermal expansions can effectively cancel the laser wavelength shift due to thermal changes in the grating pitch density G. In practice, we have applied this new technique in Raman laser assemblies operating at 785 nm wavelength to render the peak wavelength stable to within 0.02 nm from −10 degrees C. to +60 degrees C.

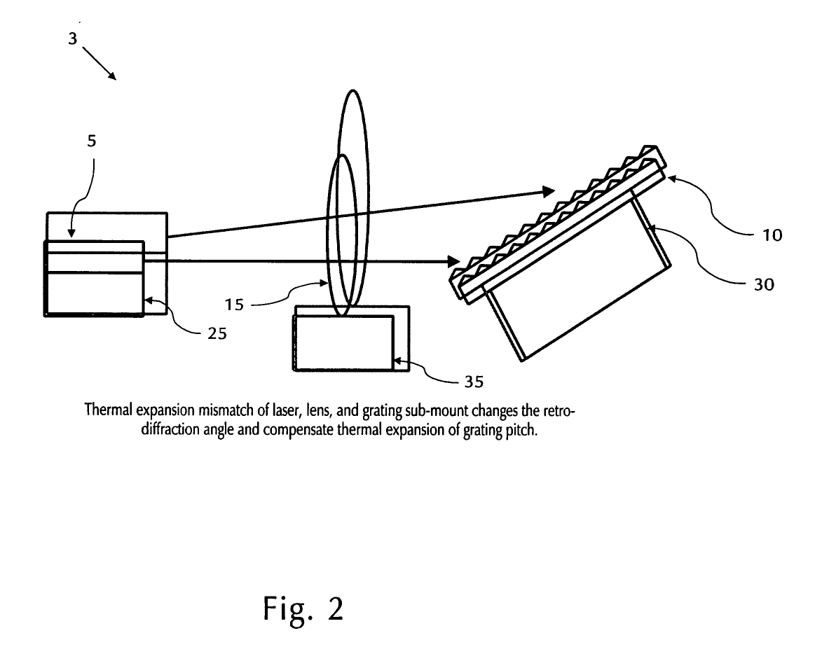

One manifestation of this idea is schematically illustrated in the external cavity wavelength stabilized laser system 3 shown in FIG. 2. In essence, the present invention uses differential changes in temperature expansions of the various system elements to change the Littrow angle, so as to cancel out temperature-induced changes in the pitch of the diffraction grating's grooves. As a result, the laser geometry is substantially insensitive to temperature changes because the thermal expansion of the laser mount 25, lens 15, lens mount 35 and grating mount 30 can compensate for the thermal expansion of the grating pitch.

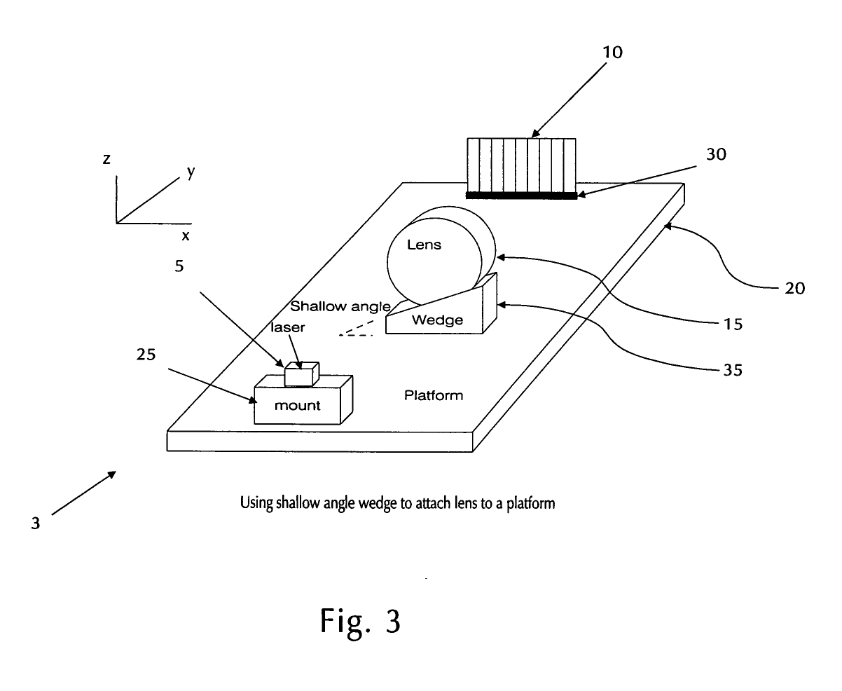

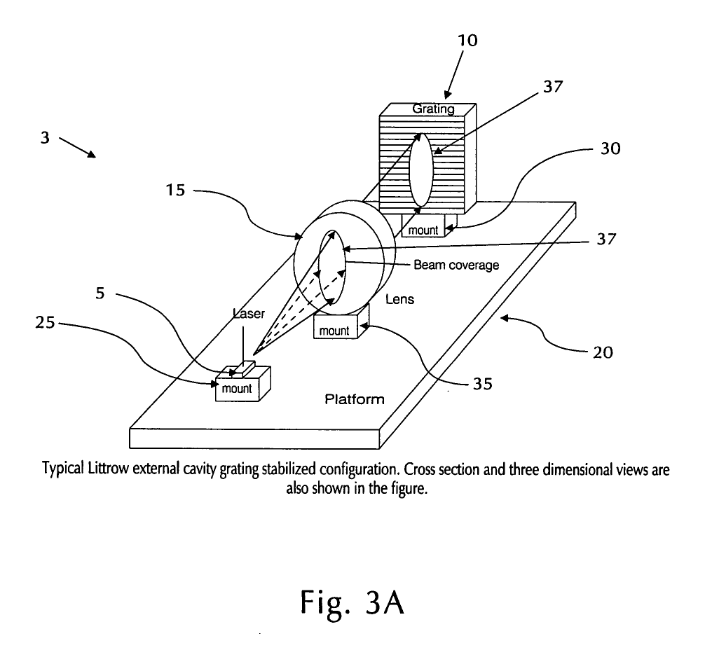

In another implementation of the present invention, and looking now at FIG. 3, there is shown an external cavity wavelength stabilized laser system 3 wherein a wedge-shaped mount 35 is used to attach lens 15 to the platform 20. As a result of this construction, if the angle of the wedge is small (e.g., <45 degree), thermal expansion of the wedge will mainly induce a lens motion in the vertical direction (i.e., the z direction in FIG. 3). Thus, if the diffraction grating 10 is arranged so that its grooves extend parallel to this vertical direction, any beam redirection due to thermally-induced lens motions will have relatively little effect on the Littrow angle. Accordingly, in this form of the invention, a wedge-shaped lens mount 35 is coordinated with the direction of the diffraction grating's grooves so as to reduce the effect of thermally-induced lens movement on the Littrow angle and thus stabilize the wavelength of the laser.

As noted above, the effect of thermal expansion of the diffractor (e.g., diffraction grating 10) and the resulting change in the diffraction characteristics of the diffractor (e.g., the thermal expansion of the grating pitch density G) inducing a shift of the laser wavelength may effectively be counterbalanced by the differential temperature expansions of the laser mount 25, lens mount 35 and/or grating mount 30. In this respect, it should be appreciated that differential temperature expansions of the laser mount 25, lens mount 35 and grating mount 30 may also be used to effectively counterbalance (i.e., offset) effects other than a change in the diffraction characteristics of the diffractor. Thus, if the diffraction grating is substantially insensitive to temperature, it can still be important to counterbalance the various effects of temperature expansion of the various elements so as to maintain the Littrow angle. By way of example but not limitation, if temperature expansion of the laser mount 25 causes a change in the incident angle of the diffractor, the lens mount 35 may be configured to counterbalance this change in the incident angle of the diffractor so as to maintain the Littrow angle. It should be noted that any one or more of laser mount 25, lens mount 35 or grating mount 30 may act as a counterbalancing element for a change in the incident angle of the diffractor caused by another element.

Looking next at FIG. 3A, to achieve high power laser operation (e.g., for use in Raman pump applications), wavelength stabilized broad area lasers are commonly used. Such lasers are commonly characterized by multiple transverse modes that have a single lateral mode operation.

More specifically, for typical lasers (including lasers which are characterized by broad area multiple transverse modes but single lateral modes), the divergence in the lateral direction (i.e., perpendicular to the epitaxial growth surface) is larger than in the transverse direction (i.e., in-plane of the epitaxial growth surface). Since lasers are traditionally die mounted so that the epitaxial growth surface (i.e., the wafer surface) is parallel to the laser sub-mount, the “fast axis” (i.e., the plane of higher diverging beam defined by the lateral mode) is perpendicular to the sub-mount, so that the elliptical far-field of the laser is elongated at an angle perpendicular to the sub-mount surface. See FIG. 3A, where the laser's beam coverage is shown at 37.

In connection with the foregoing, it should also be appreciated that, although the techniques presented in this disclosure may be more obvious for multiple transverse mode broad area lasers that have single lateral mode operation, the techniques may also be applicable for single spatial mode lasers.

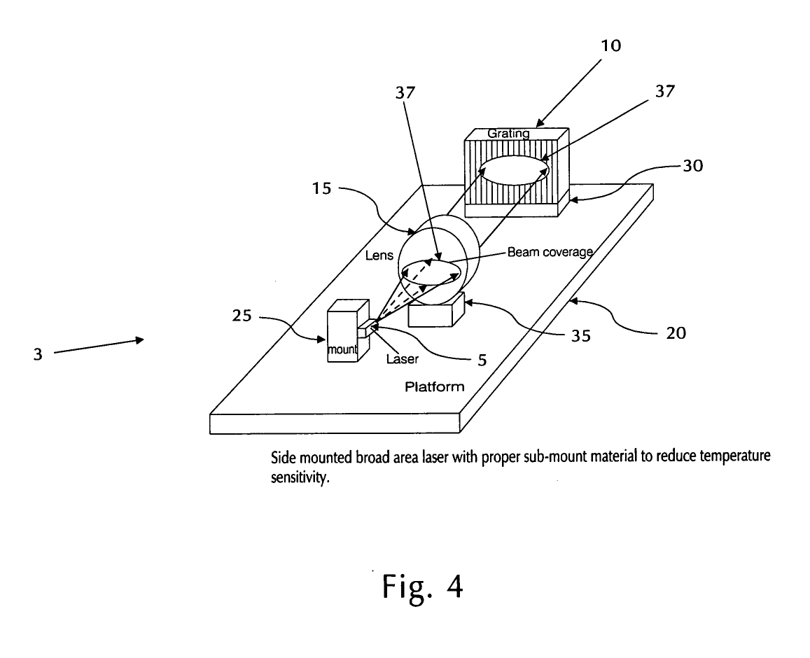

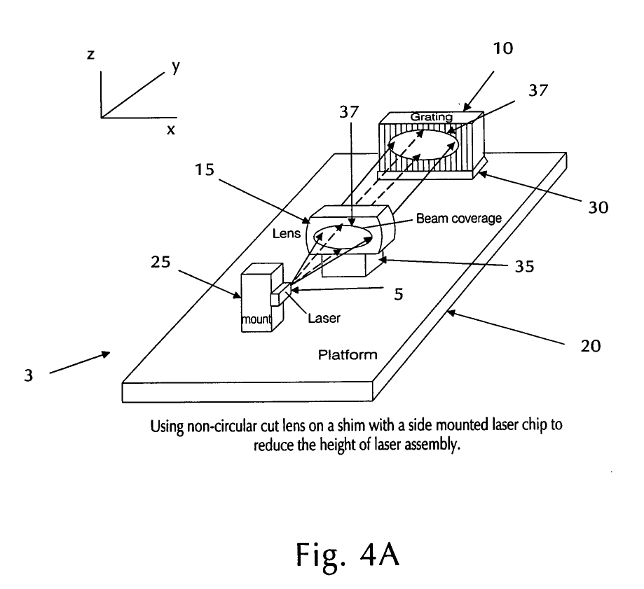

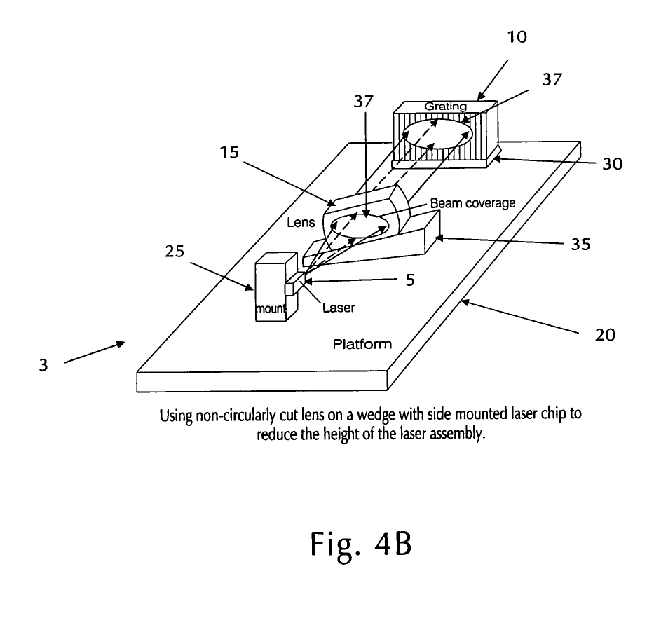

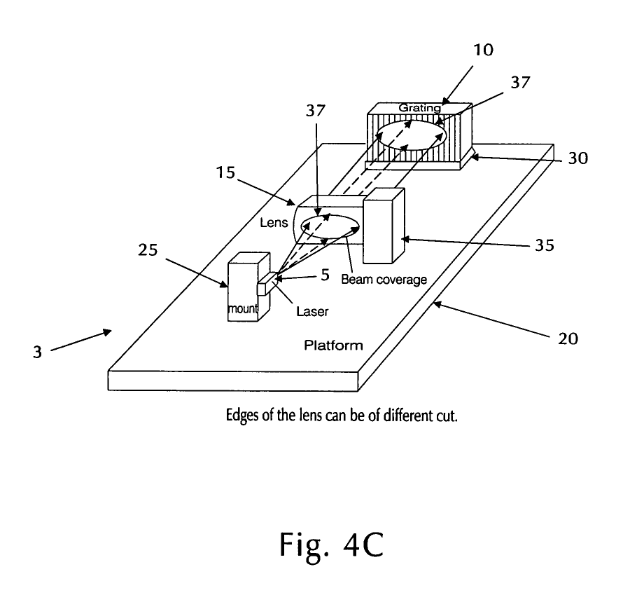

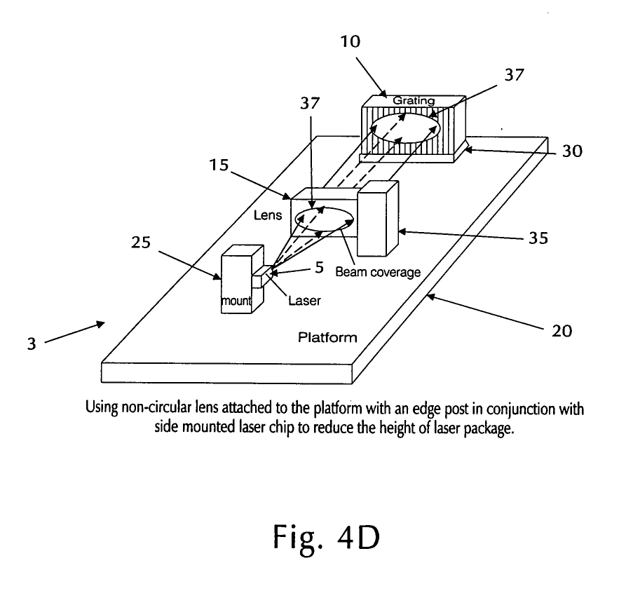

Thus, and looking now at FIG. 4, if these broad area lasers 5 are mounted on their side such that the plane defined by the diverging angle of the lateral mode is parallel to the plane of the platform 20, and the grooves of the diffraction grating 10 extend perpendicular to the plane of the platform, the laser wavelength becomes relatively insensitive to the vertical displacement of the laser mount 25, lens mount 35, and grating mount 30, and the vertical displacement of the laser chip 5 and lens 15. Of course, the grating pitch density may still change with temperature, thus effecting laser wavelength. However, by properly choosing the material of the laser mount 25 so that it will cancel the effect of the grating pitch density change on wavelength, a temperature-insensitive operation can be achieved. With the side-mounted geometry shown in FIG. 4, a laser mount material can be chosen so as to cancel the grating pitch density change effect on laser wavelength for a relatively large temperature range. In practice, this technique has been applied to a broad area laser emitting more than 500 mW at 785 nm to achieve less than 0.02 nm wavelength shift for a temperature range from −10 degrees C. to +60 degrees C., by using copper as the laser mount material with standard grating material.

Significantly, the side-mounted laser geometry of FIG. 4 offers a significant opportunity to reduce the height profile of the external cavity wavelength stabilized laser system 3.

More particularly, as seen in FIG. 3A, with a traditional top-mounted geometry, the long axis of the elliptical beam coverage 37 extends vertically relative to the plane of platform 20. This results in a relatively high profile for system 3. Among other things, in view of this construction, standard bulk curved elements (i.e., those which are symmetrical about the optical axis) are traditionally used to form lens 15. For the purposes of the present description, these standard bulk curved elements may be considered to be “spherical” in construction, in the sense that they are fully symmetrical about the optical axis.

However, as seen in FIG. 4, with the novel side-mounted geometry of the present invention, the long axis of the elliptical beam coverage 37 extends parallel to the plane of platform 20, and only the short axis of the elliptical beam coverage 37 extends vertically relative to the plane of platform 20. This provides a unique opportunity to reduce the height profile of the external cavity wavelength stabilized laser system 3, by reducing the height of lens 15, as will hereinafter be discussed in further detail. Such a reduction in the height profile of external cavity wavelength stabilized laser system 3 is extremely useful when forming compact handheld devices, such as a compact handheld Raman analyzer.

Looking now at FIG. 4A, to reduce the height profile of the external cavity wavelength stabilized laser system 3, (i) laser 5 is side-mounted so as to orient the long axis of the elliptical beam coverage 37 parallel to the plane of platform 20 and so as to orient the short axis of the elliptical beam coverage 37 vertically relative to the plane of platform 20, (ii) lens 15 is modified so as to eliminate the unused top and bottom portions of the lens so as to reduce its height profile, and (iii) diffraction grating 10, laser mount 25, lens mount 35 and grating mount 30 are shortened to the extent needed, so as to allow the height profile of system 3 to approach the dimension of the short axis of the elliptical beam coverage 37. This technique has the advantage of significantly reducing the height profile of system 3 and, in addition, since the height reduction is achieved by reducing the size of system components, weight reduction is also achieved.

Thus, and looking now at FIG. 4A, in accordance with the present invention, the height profile of system 3 is reduced by reducing the length of lens 15 in the z direction. In one preferred form of the invention, lens 15 is configured so as to have a working geometry (working surface) which is shortened in the z direction so as to substantially match the length of the elliptical beam coverage 37 in the z direction, i.e., so that there is relatively little unused lens geometry in the z direction, whereby to minimize the height profile of system 3. In another preferred form of the invention, lens 15 is configured so that its working geometry (working surface) conforms as closely as possible to the elliptical beam coverage 37 of laser 5, whereby to minimize the height profile of system 3.

In one form of the invention, the lens 15 can be a spherical element which has been cut (or diced) down in the z direction so as to reduce its dimension in the z direction. In other words, lens 15 can be a standard bulk curved element which is completely symmetrical about its optical axis except that it has been cut down in the z direction so as to provide a lower system profile. For the purposes of the present description, lens 15 may be considered to be “diced spherical” in construction.

It is to be appreciated that other optical geometries may be used for lens 15 so as to form a reduced profile system. In general, these geometries maintain lens length in the x direction while having a reduced lens length in the z direction. For example, various non-spherically symmetrical geometries (i.e., those not symmetrical about all axes) may be utilized to form lens 15.

Looking now in FIG. 4B, it should also be appreciated that, in this form of the invention (i.e., the laser side-mount geometry combined with the lens reduced height geometry), lens mount 35 may utilize a wedge construction as previously discussed.

Furthermore, as seen in FIG. 4C, lens 15 may be side-mounted to its lens mount 35. Such a construction may be advantageous in further reducing the height profile of system 3.

FIG. 4D shows a non-circular lens 15 side-mounted to its lens mount 35.

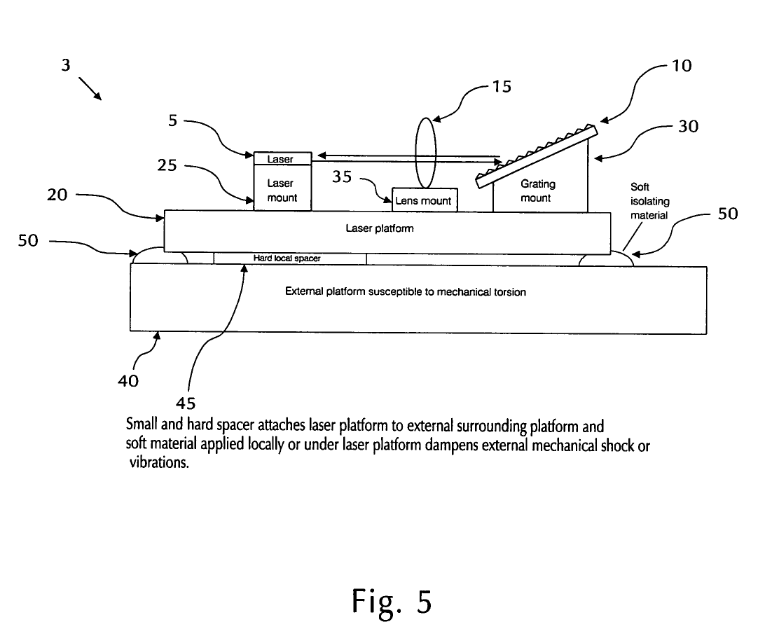

Looking next at FIG. 5, there is shown another external cavity wavelength stabilized laser system 3 which embodies a further implementation of the present invention. More particularly, if the laser platform 20 mechanically deforms due to external stress (either temperature or mechanicanically induced), misalignment of the system components can occur, resulting in a change of the Littrow angle and thus affecting the external cavity laser wavelength. To this end, the laser platform 20 can be, to at least some extent, mechanically isolated from the outside (e.g., from the external platform 40) by using a relatively small, thin, hard local spacer 45 and segments of soft isolating material 50. The hard local spacer 45 provides relatively rigid mechanical attachment to the outside world through the externally supplied platform 40 (i.e., chassis) and can be thermally conductive so as to heat-sink the laser 5 (in which case the spacer 45 is preferably attached directly beneath the laser mount 25). The segments of soft isolating material 50 serve as shock/vibration absorbers to dampen external forces, and may comprise epoxy or similar materials. Thus, in this aspect of the invention, the laser platform 20 is attached to an external platform 40 via (i) a small, hard and potentially thermally conductive spacer 45, and (ii) segments of soft material 50, so as to reduce the effect of mechanical deformations and distortions on the wavelength of the external cavity laser.

The present disclosure discusses the present invention in the context of an external cavity grating stabilized laser, although the concepts of this invention also apply to thin-film wavelength stabilized lasers.

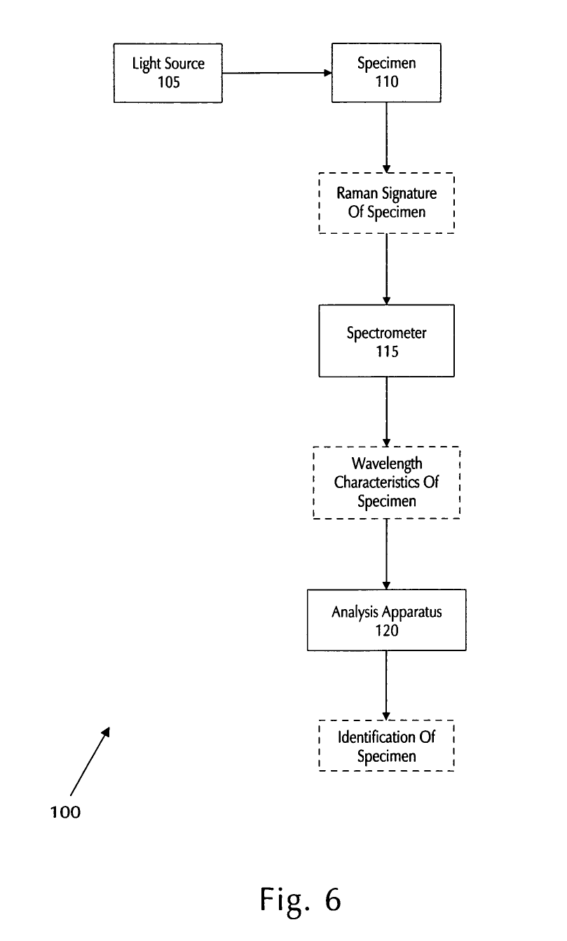

It is possible to utilize the novel external cavity temperature stabilized laser of the present invention in many applications. It is particularly useful a portable applications requiring stable, narrow-linewidth light signals. Thus, for example, in FIG. 6 there is shown novel Raman analyzer 100 formed in accordance with the present invention. Raman analyzer 100 generally comprises a light source 105 for delivering excitation light to a specimen 110 so as to generate the Raman signature for that specimen, a spectrometer 115 for receiving the Raman signature of the specimen and determining the wavelength characteristics of that Raman signature, and analysis apparatus 120 for receiving the wavelength information from spectrometer 115 and, using the same, identifying specimen 110. In accordance with the present invention, light source 105 comprises an uncooled, external cavity wavelength stabilized laser formed in accordance with the present invention. By way of example, light source 105 may comprise a laser system such as that shown in FIGS. 1-5. By virtue of the fact that the Raman analyzer 100 utilizes the uncooled, low profile, external cavity wavelength stabilized laser system of the present invention, the entire Raman analyzer can be made smaller and more power efficient, which is a significant advantage in portable handheld applications.

It will be appreciated that still further embodiments of the present invention will be apparent to those skilled in the art in view of the present disclosure. It is to be understood that the present invention is by no means limited to the particular constructions herein disclosed and/or shown in the drawings, but also comprises any modifications or equivalents within the scope of the invention.

What is claimed is:

1. A low profile external cavity wavelength stabilized laser system comprising:
a platform extending in an x-y plane;
a laser mounted to the platform;
a diffractor mounted to the platform; and
a lens mounted to the platform between the laser and the diffractor so as to transmit light therebetween, wherein the lens is formed so as to have a reduced size in the z direction.

2. A system according to claim 1 wherein the laser is of the type which provides a substantially elliptical beam coverage.

3. A system according to claim 2 wherein the laser is mounted to the platform so that the divergence of light in the z direction is less than the divergence of light in the x direction.

4. A system according to claim 1 wherein the laser is mounted to the platform with a laser mount, and further wherein the laser is side-mounted to the laser mount.

5. A system according to claim 1 wherein the laser comprises an epitaxial growth surface, and further wherein the laser is mounted to the platform so that the plane defined by the epitaxial growth surface is substantially perpendicular to the plane of the platform.

6. A system according to claim 1 wherein the laser is characterized by multiple transverse modes that have a single lateral mode of operation.

7. A system according to claim 6 wherein the plane defined by the diverging angle of the lateral mode is substantially parallel to the plane of the platform.

8. A system according to claim 1 wherein the laser is characterized by a single spatial mode of operation.

9. A system according to claim 1 wherein the diffractor is a diffraction grating.

10. A system according to claim 9 wherein the grooves of the diffraction grating extend in the z direction.

11. A system according to claim 1 wherein the diffractor is a thin film dispersive filter.

12. A system according to claim 1 wherein the lens is formed with a diced spherical geometry.

13. A system according to claim 1 wherein the lens is formed with a diced non-circular construction.

14. A system according to claim 1 wherein the laser is of the type which provides a substantially elliptical beam coverage, wherein the laser is mounted to the platform so that the long axis of the laser's elliptical bean coverage extends in the x direction, and further wherein the lens is configured so as to have a working geometry which is shortened in the z direction so as to substantially match the length of the laser's elliptical beam coverage in the z direction.

15. A system according to claim 1 wherein the laser is of the type which provides a substantially elliptical beam coverage, wherein the laser is mounted to the platform so that the long axis of the laser's elliptical bean coverage extends in the x direction, and further wherein the lens is configured so that its working geometry substantially conforms to the elliptical beam coverage of the laser.

16. A system according to claim 1 wherein the lens is mounted to the platform with a lens mount.

17. A system according to claim 16 wherein the lens mount is substantially wedge shaped.

18. A system according to claim 16 wherein the lens is side-mounted to the lens mount.

19. A method for generating light, comprising:
providing a low profile external cavity wavelength stabilized laser system comprising:
a platform extending in an x-y plane;
a laser mounted to the platform;
a diffractor mounted to the platform; and
a lens mounted to the platform between the laser and the diffractor so as to transmit light therebetween, wherein the lens is formed so as to have a reduced size in the z direction; and
activating the laser.

20. A system according to claim 19 wherein the laser is of the type which provides a substantially elliptical beam coverage.

21. A system according to claim 20 wherein the laser is mounted to the platform so that the divergence of light in the z direction is less than the divergence of light in the x direction.

22. A system according to claim 19 wherein the laser is of the type which provides a substantially elliptical beam coverage, wherein the laser is mounted to the platform so that the long axis of the laser's elliptical bean coverage extends in the x direction, and further wherein the lens is configured so as to have a working geometry which is shortened in the z direction so as to substantially match the length of the laser's elliptical beam coverage in the z direction.

23. A system according to claim 19 wherein the lens is mounted to the platform with a lens mount, and further wherein the lens is side-mounted to the lens mount.

24. A Raman analyzer comprising:
a light source for delivering excitation light to a specimen so as to generate the Raman signature for that specimen;
a spectrometer for receiving the Raman signature of the specimen and determining the wavelength characteristics of that Raman signature; and
analysis apparatus for receiving the wavelength information from the spectrometer and, using the same, identifying the specimen;
wherein the light source comprises a low profile external cavity wavelength stabilized laser system comprising:
a platform extending in an x-y plane;
a laser mounted to the platform;
a diffractor mounted to the platform; and
a lens mounted to the platform between the laser and the diffractor so as to transmit light therebetween, wherein the lens is formed so as to have a reduced size in the z direction.

25. A system according to claim 24 wherein the laser is of the type which provides a substantially elliptical beam coverage.

26. A system according to claim 25 wherein the laser is mounted to the platform so that the divergence of light in the z direction is less than the divergence of light in the x direction.

27. A system according to claim 24 wherein the laser is of the type which provides a substantially elliptical beam coverage, wherein the laser is mounted to the platform so that the long axis of the laser's elliptical bean coverage extends in the x direction, and further wherein the lens is configured so as to have a working geometry which is shortened in the z direction so as to substantially match the length of the laser's elliptical beam coverage in the z direction.

28. A system according to claim 24 wherein the lens is mounted to the platform with a lens mount, and further wherein the lens is side-mounted to the lens mount.

29. A method for identifying a specimen, comprising:
delivering excitation light to the specimen so as to generate the Raman signature for that specimen;
receiving the Raman signature of the specimen and determining the wavelength characteristics of that Raman signature; and
identifying the specimen using the wavelength characteristics of the Raman signature;
wherein the excitation light is delivered to the specimen using a low profile external cavity wavelength stabilized laser system comprising:
a platform extending in an x-y plane;
a laser mounted to the platform;
a diffractor mounted to the platform; and
a lens mounted to the platform between the laser and the diffractor so as to transmit light therebetween, wherein the lens is formed so as to have a reduced size in the z direction.

30. A system according to claim 29 wherein the laser is of the type which provides a substantially elliptical beam coverage.

31. A system according to claim 30 wherein the laser is mounted to the platform so that the divergence of light in the z direction is less than the divergence of light in the x direction.

32. A system according to claim 29 wherein the laser is of the type which provides a substantially elliptical beam coverage, wherein the laser is mounted to the platform so that the long axis of the laser's elliptical bean coverage extends in the x direction, and further wherein the lens is configured so as to have a working geometry which is shortened in the z direction so as to substantially match the length of the laser's elliptical beam coverage in the z direction.

33. A system according to claim 29 wherein the lens is mounted to the platform with a lens mount, and further wherein the lens is side-mounted to the lens mount.
